(19) United States
(12) Patent Application Publication
(10) Pub. No.: US 2004/0070310 A1
(43) Pub. Date: Apr. 15, 2004

(54) Device comprising a variable-rigidity mobile structure preferably with electrostatic control

(76) Inventors: Eric Ollier, Grenoble (FR); Roy David, Grenoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,065

(22) PCT Filed: Dec. 20, 2001
(86) PCT No.: PCT/FR01/04116

(30) Foreign Application Priority Data
Dec. 21, 2000 (FR) 00/16765

(51) Int. Cl. H02N 1/00

(52) U.S. Cl. 310/309

(57) ABSTRACT

Device comprising a mobile structure with variable stiffness, preferably with electrostatic control.

The stiffness of the mobile structure (12) is modified during its displacement, in order to reduce the electrical instability area, partially linearize the deformation curve and/or increase the amplitude of the deformation for a negligible increase in the control voltage. This may be achieved by the use of a fixed structure (12) with a surface (S) on which a flexible beam (22) of the mobile structure (12) bears at at least one point (P).

### TECHNICAL FIELD

The invention relates to a device comprising a mobile mechanical structure capable of moving under the action of control means, preferably of the electrostatic type.

The invention is particularly applicable to production of micro actuators controlled by electrostatic combs with a variable air gap. However, other applications are possible whenever it is desirable to have optimized devices, in other words compact devices responding to a low control voltage, while being capable of producing a large force or displacement.

### STATE OF THE ART

Existing electrostatic actuators may be separated into two categories, depending on their operating mode.

The first category applies to actuators controlled by electrostatic combs with variable air gap. These actuators use the force normal to the planes of electrodes created when a potential difference is applied between the electrodes. This force tends to bring the two electrodes closer to each other.

The second category applies to actuators controlled by electrostatic combs with variable area, frequently called “inter-digitized combs”. These actuators use the lateral force parallel to the plane of the electrodes created when a potential difference is applied between the electrodes. This force tends to align the two electrodes with respect to each other.

These two types of actuators are currently used for micro systems (MEMS, MOEMS, etc.). They are made using microtechnologies derived from microelectronics.

Variable area combs are the most frequently used in this particular context, for size reasons.

However, variable air gap combs are used in preference when actuators are made from insulating materials that require metallic depositions on the sides to form electrodes. Variable area combs are difficult to use in this case, since very thin air gaps (spaces between electrodes) are necessary for satisfactory operation, and these thin air gaps are difficult to obtain due to difficulties in metallizing electrodes.

However, variable air gap combs have inherent disadvantages that make it impossible to optimize their efficiency, in other words to minimize the size and control voltage while maintaining a large force or displacement.

These disadvantages specific to variable air gap combs are firstly the risk of an electrical discharge (breakdown) in the medium between the two electrodes, and secondly the “electrical instability” problem.

Different solutions are known to solve the problem that arises due to the risk of electrical discharge.

A first of these solutions is to increase the spacing between the electrodes. However, this increases the control voltage and/or the size.

Another solution consists of modifying the nature of the medium separating the electrodes, for example by replacing air by a more appropriate gas, for example SF₆, to increase the electrical strength. This solution consists of implementing an encapsulation technique that must also provide a certain degree of leak tightness, which results in additional technological difficulties and an increase in the cost of the device.

The breakdown problem can also be solved by creating a vacuum around the electrodes and consequently around the mechanical structure. However, like the previous solution, this solution imposes encapsulation and furthermore it eliminates the damping effect due to gas.

The electrical instability phenomenon occurs due to the fact that a voltage applied between the electrodes simultaneously deviates the mechanical part and reduces the clearance or the electrostatic air gap. However, the electrostatic force is greater when the width of the air gap is smaller. Therefore, the deviation produced by the voltage applied between the electrodes is accompanied by an increase in the electrostatic force, which in turn tends to increase the deviation. Consequently, an “instability threshold” is reached when the voltage is increased, beyond which the mechanical stiffness of deformed structure no longer compensates the electrostatic force. Before this threshold, the position of the mechanical structure is entirely determined by the applied voltage. Beyond the instability threshold, the mobile structure spontaneously moves until the electrodes come into contact, which results in a short circuit and frequently partial destruction of the device.

For example, in the special case of a beam with a cantilever and with one fixed end and one free end on which an electrostatic force is applied, the instability threshold corresponds to a deviation equal to one third of the air gap.

Therefore, considering this electrical instability phenomenon, the width of the air gap should be made equal to at least three times the required mechanical deformation fixed by the application. This results in assigning high values to the size of the electrostatic comb and the voltage to be applied, which is a significant disadvantage of this type of device.

The publication by J. Mohr, M. Khol and W. Mentz entitled “Micro-Optical Switching by Electrostatic Linear Actuators with Large Displacements”, The 7^{th} International Conference on Solid-State Sensors and Actuators, 1993, pages 120-123, and the publication by R. Legtenberg, J. Gilbert, S. D. Senturia and M. Elwenspoek “Electrostatic Curved Electrode Actuators” Journal of Microelectromechanical Systems, Vol. 6, No. 3, September 1997, pages 257-265, describes solutions for limiting this disadvantage.

The first of these publications describes triangular shaped electrodes. The second publication describes curved electrodes. The purposes of these special electrode shapes are to increase the amplitude of the deformation or to reduce the control voltage by directly varying the nature of the electrostatic control. For example, the curved shape reduces energy losses close to the built-in fixed end of the electrode.

It is also known how to use electrical instability to obtain very large deviations, by deliberately passing through the instability area and stopping the deviation using a mechanical stop, just before the electrodes come into mutual contact. However, these devices do not have, any stable intermediate position in the instability area.

In conclusion, when an attempt is made to make a stable deviation of a mechanical structure, there are important limits related to electrostatic operation. These limits make it necessary to have a very large air gap to avoid the instability area, a high control voltage and large size and/or by non-linear operation of the electrostatic control.

### PRESENTATION OF THE INVENTION

One purpose of the invention is a device comprising a mobile mechanical structure with an innovative design that enables a large force or displacement, while remaining quite compact and responding to a low control force. The invention can also make operation, in other words deviation as a function of the control voltage, linear over much of its range.

According to the invention, this result is obtained using a device comprising a fixed structure, a mobile structure connected to the fixed structure by flexible support means, and control means capable of displacing the mobile structure, the device having a given global stiffness and being characterized in that the mechanical stiffness control means are associated with the mobile structure and are capable of modifying the said global stiffness so that it varies with the displacement of the mobile structure.

In this case, the stiffness control means are capable of advantageously modifying the global stiffness of the device so that it increases progressively with the displacement of the mobile structure.

According to one advantageous application of the invention, the control means are of the electrostatic type. However, other types of control means can be used. For example, the control means may consist of a drive system external to the mobile part, for example they may be capable of applying an acceleration to the device.

The stiffness control means may be in different forms, without going outside the framework of the invention.

Thus, in a first embodiment, a beam fixed to the mobile structure is supported by at least one point on the fixed structure materializing the stiffness control means, at least one of the elements consisting of the beam and the fixed structure being flexible, and the shape of these elements being such that the location of the said point varies with the deflection of the said flexible element. Depending on the case, the beam can then be either a beam used in the flexible support means connecting the mobile structure to the fixed structure, or an element added to the mobile structure and different from the flexible support means.

In another embodiment, the mobile structure bears on an add-on flexible structure at at least one point, materializing the stiffness control means, the stiffness of the add-on flexible structure varying with the position of the mobile structure.

In yet another embodiment, the mobile structure is in friction contact with at least one presser device materializing the stiffness control means, the said presser device being applied in contact with the mobile structure with an adjustable pressure. In this case, the presser device may be applied in contact with the mobile structure through a passive or active means. A “Passive means” refers to a means capable of applying the presser device into contact with the structure without the addition of energy external to the device, and “active means” means a means using energy external to the device.

### BRIEF DESCRIPTION OF THE DRAWINGS

We will now describe different embodiments of the invention as non-limitative examples with reference to the appended drawings in which:

FIG. 1 is a longitudinal sectional view, diagrammatically illustrating a first embodiment of a device according to the invention;

FIG. 2 is a curve that represents variations in the control voltage V (in volts) as a function of the displacement Δ (in μm) of the mobile structure, for a constant stiffness Ko (prior art) (curve A), for a variable stiffness Kl (y) greater than Ko (curve B) and for a stiffness K2 (y) greater than K1 curve C);

FIG. 3 is a sectional view comparable to FIG. 1, illustrating two variants of a second embodiment of the invention, on the left and right parts;

FIG. 4 is a sectional view comparable to FIGS. 1 and 3, illustrating a third embodiment of the invention;

FIG. 5 is a sectional view comparable to FIGS. 1, 3 and 4 illustrating a fourth embodiment of the invention;

FIG. 6 is a sectional view comparable to FIGS. 1, 3 to 5, illustrating a fifth embodiment of the invention;

FIG. 7 shows curve g(a) for different values of the stiffness K at D, E, F and G, in a numeric example corresponding to the embodiment in FIG. 1;

FIG. 8 shows the deformed shape y(x) of the beam in FIG. 1 in the case in which there are no support points (curve H), and for values of the [a, g (a)] pair for which the stiffness k is the same (curve I);

FIG. 9 is a graph that shows the deformed shape corresponding to deviation y1 and stiffness k1 (curve J1), and the value of g2(a) for stiffness k2 (curve L);

FIG. 10 shows three theoretically possible deformed shapes y(x) at M, N and O, and the corresponding support points ai; and

FIG. 11 shows the successive deformations y(x) obtained for the beam in FIG. 1, in the example considered.

### DETAILED DESCRIPTION OF SEVERAL PREFERRED EMBODIMENTS OF THE INVENTION

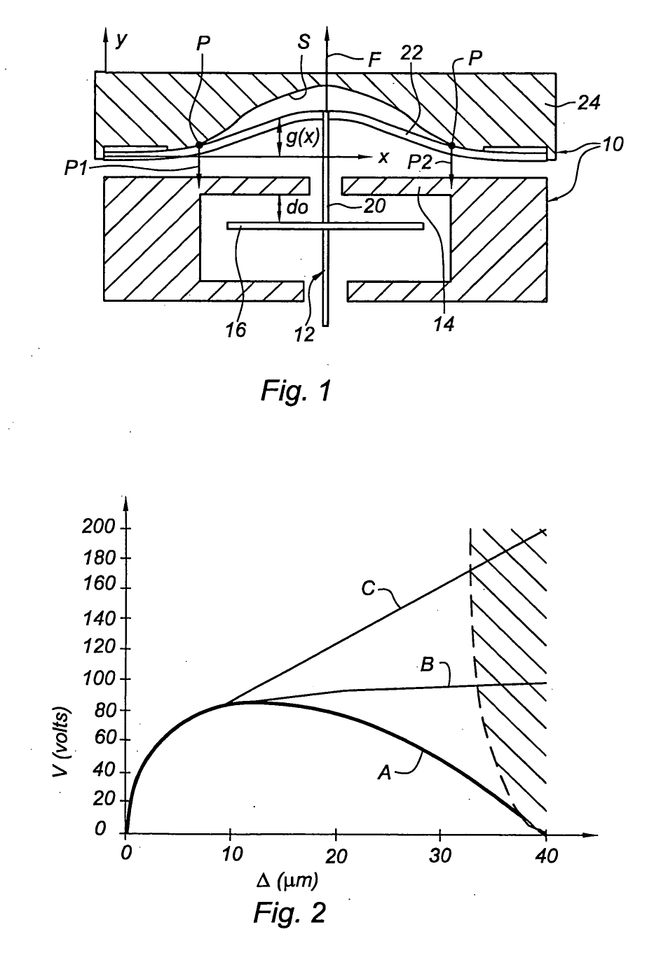

The different embodiments of the invention illustrated as examples in FIGS. 1 and 3 to 6 all apply to electrostatic control devices in which a mobile structure 12 is connected to a fixed structure 10 through flexible support means that comprise at least one flexible support beam 22.

More precisely, in all cases, the fixed structure 10 comprises a fixed comb 14 and the mobile structure 12 comprises a mobile comb 16. The fixed comb 14 and the mobile comb 16 form control means and are separated by an air gap with a value equal to do when the device is not activated.

An appropriate control voltage V can be applied conventionally between the fixed comb 14 and the mobile comb 16. The effect of applying the control voltage V is to move the mobile comb 16 towards the fixed comb 14, in the direction that tends to reduce the value of the air gap, in other words in the direction y parallel to the axis of the rod 20 in FIG. 1.

In the different embodiments diagrammatically shown in FIGS. 1 and 3 to 6, the mobile structure 12 also comprises the rod 20 on which the mobile comb 16 is fixed. The rod 20 is the mechanical structure that connects the mobile comb 16, the flexible support beam 22 and the rest of the mobile structure together. One part, such as the central part of the flexible support beam 22, is fixed to one end of the rod 20 and to at least one other part of the beam 22, such that its end is built into the fixed structure 10.

In the conventional arrangement described so far, the global stiffness of the device has a given value Ko, determined mainly by the flexibility of the support beam 22.

In this arrangement, the electrical displacement force F_{elec} applied on the mobile structure 12 by the control means can be written:

$${F}_{elec} = \frac{1}{2} ϵ \cdot S \cdot \frac{{V}^{2}}{{( d o - Δ y )}^{2}}$$

where ε is the dielectric constant of the material forming the beam 22, S is the surface area of the facing electrodes, do is the value of the air gap at rest, Δy is the displacement of the mobile structure 12, in other words the maximum deformation of the beam 22, and V is the control voltage applied to the control means.

Furthermore, the mobile structure is subjected to a mechanical return force F_{mecha} that can be written:

F_{mecha}=Ko.(do−Δy).

The system is stable as long as the return force balances the electrical force which is expressed simply as F_{elec}=F_{mecha}. The control voltage V necessary to control the displacement Δy of the mobile structure 12 at equilibrium (static) is deduced:

$$V = [ d o - Δ y ] \sqrt{\frac{2 \cdot K o \cdot Δ y}{S \cdot ϵ}} \qquad ( 1 )$$

The curve V(Δy) passes through a minimum at Δy=do/3. When the displacement of the mobile structure exceeds this value, the device becomes unstable and the electrodes come and stay in contact with each other.

According to the invention, stiffness control means are associated with the mobile structure 12 so as to modify the global stiffness of the device. More precisely, the stiffness control means are mechanical means arranged such that the global stiffness of the device progressively increases with the displacement of the mobile structure 12 controlled by the control means.

In the embodiment of the invention illustrated in FIG. 1, the stiffness control means are materialized by a rigid part 24 belonging to the fixed structure 10. This part 24 comprises a surface S, with which the flexible support beam 22 is in contact through at least one point P (in FIG. 1, the beam 22 is in contact with the surface S at two points P). The shape of the surface S provided on the rigid part 24 is such that the contact point(s) P on the flexible support beam 22 become closer to the centerline of the rod 20 when the deformation Ay of the beam increases. Consequently, the stiffness of the device increases with the deformation of the mobile structure, in other words with the displacement force applied on this structure.

Since the stiffness of the device varies during deformation of the mobile structure 12, this stiffness is expressed in the form of a function K(y) and equation (1) becomes:

$$V = [ d o - Δ y ] \sqrt{\frac{2 \cdot K ( y ) \cdot Δ y}{S ϵ}} \qquad ( 2 )$$

By choosing the function K(y), the stability limit, and more generally the curve V(Δy) are fixed directly. FIG. 2 shows the variation of the control voltage V as a function of the displacement Δy of the mobile structure 12, at A when the stiffness is constant and equal to Ko (prior art), at B when the stiffness K1(y) is greater than Ko and increases with the displacement in the y direction, and at C when the stiffness K2(y) is greater than K1(y). Thus, it is quite clear that the stiffness control means according to the invention are particularly useful for precisely controlling the behavior of the device throughout the entire zone K(y)>Ko.

Therefore, for a given value of the air gap, stable displacement of the mobile structure 12 is no longer limited to one third of this value, but rather to the breakdown limit of the material present in the air gaps. Therefore the stability limit is much wider. Furthermore, any increase in the area of the electrodes not only influences the control voltage, but also influences the maximum allowable displacement to prevent breakdown.

As will be seen later in more detail, the shape of the surface S in the embodiment in FIG. 1 may be determined to obtain a predetermined variation of the stiffness of the device as a function of the displacement force applied on the mobile structure.

Furthermore, the shape, size and cross section of the beam 22 may also be determined in advance in order to have full control over the deformed shape of the mechanical structure during the deviation.

In the device that has just been described with reference to FIG. 1, the stiffness control means materialized by the rigid part 24 of the fixed structure 10 modify the global stiffness K of the device, so as to push the electrical instability zone further away.

Alternatively, the stiffness of the device as a function of the control voltage V can also be varied by modifying the shape and size of the beam 22, for example by varying the cross section from one end to the other.

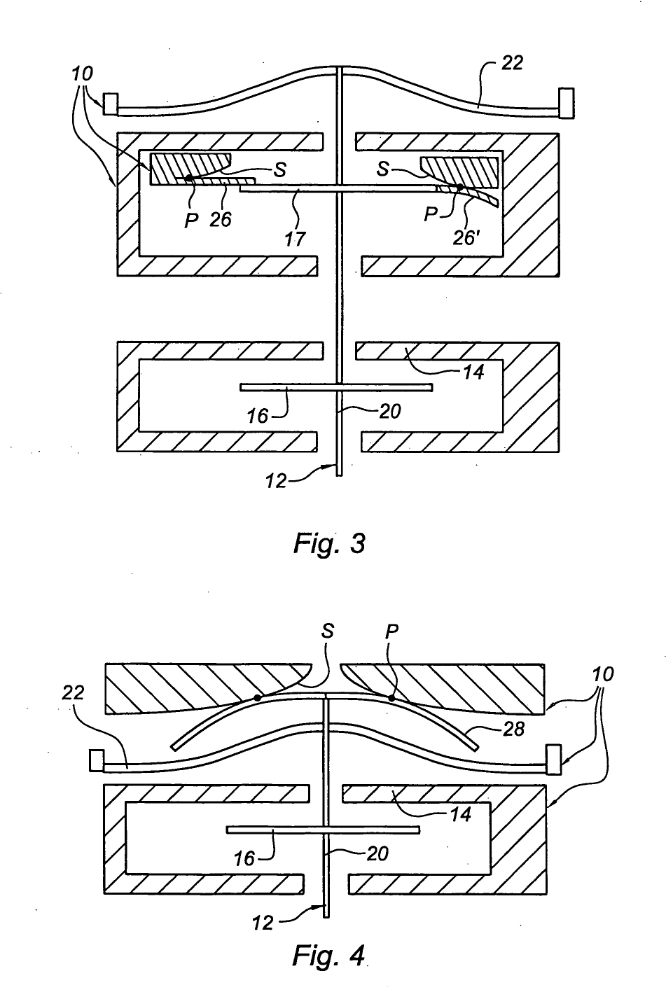

In the embodiments illustrated in FIGS. 3 to 6, the stiffness control means are different from the flexible support means 22, which is unlike the situation in FIG. 1. In the embodiment in FIG. 3, the stiffness control means comprise a complementary structure that is added to the device, so as to have a point support in contact with a determined shaped surface of the fixed structure 10.

More precisely, the left part in FIG. 3 shows the case in which the complementary structure is formed by at least one flexible beam 26 connected to the fixed structure 10 and at least one beam 17 connected to the mobile structure. The flexible beam 26 is fixed to the fixed structure at one of its ends, so as to be in contact with a surface S of the fixed structure with a determined shape at at least one point P.

Due to this arrangement, displacement of the mobile structure 12 and particularly the beam 17 in contact with the beam 26 in the direction y has the effect of deforming the flexible beam 26 such that its contact point or points P with the said surface S of the fixed structure move towards the center line of the rod 20. Thus, in the first embodiment described with reference to FIG. 1, the global stiffness of the device increases with the applied voltage.

The right part of FIG. 3 shows a variant of this second embodiment of the invention. In this variant, the complementary structure is formed from at least one flexible beam 26′ that is along the extension of the centerline of the beam 17. More precisely, the flexible beam 26′ comes into contact with one of the ends of the beam 17, so that it bears on a surface S of the fixed structure 10 with a determined shape at at least one point P. As before, the contact point or points are brought closer to the centerline of the rod when the displacement of the mobile structure 12 along the y direction increases. Therefore, the global stiffness of the device increases with the applied voltage.

In another embodiment of the invention illustrated in FIG. 4, a complementary structure comprising an arm or a flexible beam 28 is fixed to the mobile structure 12, through the rod 20. The flexible arm 28 that forms part of the mobile structure 12, bears on a surface S of the fixed support 10 with a determined shape, through at least one point P.

In the arrangement that has just been described with reference to FIG. 4, the global stiffness of the device increases with the voltage applied between the fixed comb 14 and the mobile comb 16, due to the fact that the contact point or points P gradually become closer to the center line of the rod 20 when the mobile structure 12 moves along the y direction.

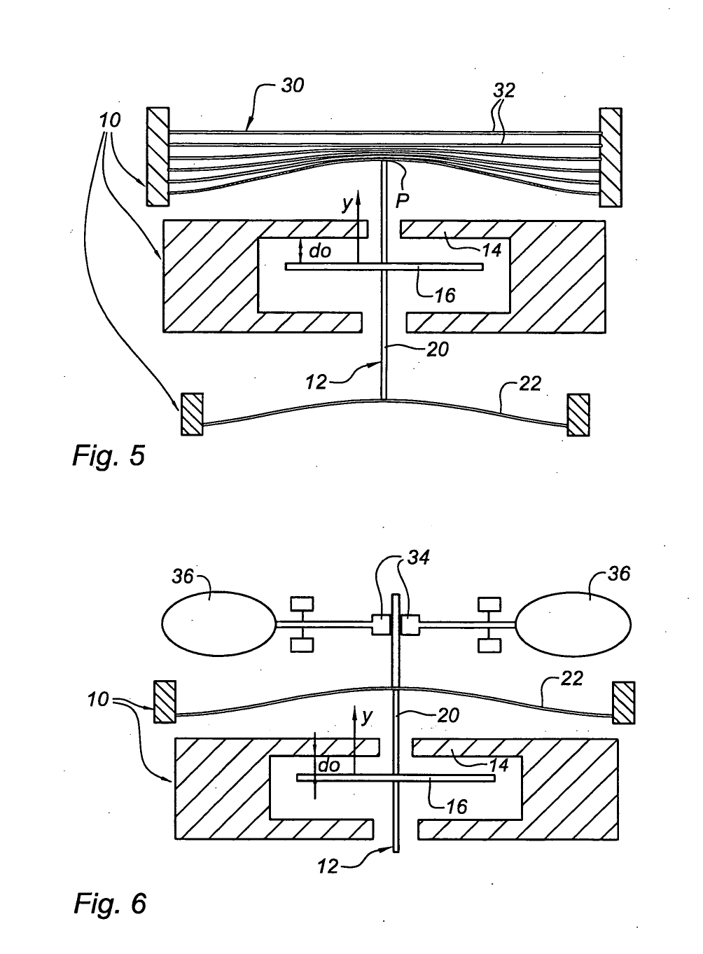

In another embodiment illustrated as an example in FIG. 5, the mobile structure 12 is in contact with a flexible complementary structure 30 itself connected to the fixed structure 10, at at least one point P.

More precisely, in the case shown in FIG. 5, one end of the rod 20 is in contact with a part of the flexible structure 30, for example formed by a set of flexible beams 32 for which the ends are built into the fixed structure 10, through a point P. The section and the length of the beams 32 can then vary as a function of the required stiffness. Furthermore, the behavior of the device is comparable to the behavior of the devices described above with reference to FIGS. 1, 3 and 4.

In yet another embodiment illustrated in FIG. 6, the stiffness control means are materialized by at least one presser device, applied in contact with the mobile structure 12 with a pressure that may be adjustable.

More precisely, in the case shown in FIG. 6, two presser devices 34 are applied in contact with the external surface of the rod 20 through presser means illustrated diagrammatically at 36. These presser means 36 may be either passive means or active means. In both cases, the presser means apply the presser devices 34 in contact with the rod 20 with a pressure that varies in a controlled manner as the displacement of the mobile structure 12 increases.

According to the invention, the different embodiments described are capable of pushing the limits of the device with electrostatic control. In particular, compared with devices according to prior art, the dimensions of the device can be reduced because the air gap can be reduced. Similarly, the applied control voltages are reduced. The instability area is made stable, so that the width of the air gap can be made approximately equal to the target deformation amplitude. Furthermore, it also becomes possible to make the control voltage linear over a large part of the displacement, or to generate the required “displacement=f(voltage)” curve. Furthermore, the structure may be mechanically stabilized, particularly because the control voltage is large. Finally, the invention is applicable to any type of electrostatic controls.

For example, using the example embodiment described above with reference to FIG. 1, we will now give a more detailed description of how the shape of the surface S can be determined to obtain the desired result.

The first step is to define the behavior V(Δy) that is required for the device considered. For example, this behavior may be defined in curve B in FIG. 2. This is equivalent to imposing values V(Δy) in the instability zone. After the initial limiting instability position, the deviation may be continued by slightly increasing the control voltage until the maximum required deviation is obtained, for example equal to 30 μm for a 40 μm air gap. Advantageously, the stiffness beyond the maximum required deviation is increased considerably, in order to stop the movement before reaching electrostatic breakdown limits.

The next step is to calculate the stiffness K(y) necessary to obtain the previously chosen curve V(Δy) This calculation is made using the relation (2) mentioned above.

This value is used to deduce the shape of the surface S of the rigid part 24 (FIG. 1) necessary to generate this variable stiffness during displacement of the mobile structure 12. This is done by defining this area by a function g(x). As illustrated in FIG. 1, this function g(x) represents the variation of the distance g separating the surface S of a plane perpendicular to the direction y and passing through the ends of the beam 22 built into the part 24, as a function of the distance x that separates the points considered on the surface S from one of the ends of the beam 22.

For the surface S thus defined, for a given deviation Δy resulting from application of a force F on beam 22 along the center line of the rod 20, the mobile beam 22 only touches the part 24 at two symmetrical points P with abscissas a and 1-a and ordinates g(a), where 1 is the length of the flexible beam.

The beam 22, built in at its ends and subjected to the central force F and bearing on the surface S at two points P, forms a third order hyperstatic system. It is easy to reduce this system to three first order systems (built in beam subjected to force F, built in beam to which the reaction force P1 of the surface S is applied at a first point P, and built in beam subjected to the reaction force P2 of the surface S at a second point P, the forces P1 and P2 having opposite signs to force F) and therefore for which the solutions are known. The total deformed shape Y(x) of the beam 22 is then simply expressed as the superposition of the three deformed shapes Y1(x), Y2(x) and Y3(x) of each first order systems, which results in:

Y(x)=Y1(x)+Y2(x)+Y3(x).

The forces P1 and P2 are determined considering that the beam 22 passes through the contact points at x=a and x=1-a. Therefore we can write:

Y(a)=Y(1-a)=g(a).

Consequently, the forces P1 and P2 can be eliminated and the equation of the deformed shape can be determined solely as a function of the central force F applied on the beam and the coordinates [a, g(a)], [1-a, g(a)] of the support points.

After thus determining the deformed shape Y of the beam 22, the maximum deviation of the beam is calculated, corresponding to the value Ymax of the deformed shape Y for x=½ in the example considered.

The next step is to determine the effective stiffness K_{calculated}[g(a), Ymax] of the system, using the relation:

F=K(ymax).Ymax

In the example described with reference to FIG. 1, the effective stiffness of the system is given by the relation:

$${K}_{calculated} [ g ( a ) , y max ] = E \cdot I [ \frac{288 \cdot {a}^{2} - 192 \cdot a \cdot l + \frac{g ( a )}{y max} ( 72 \cdot {l}^{2} - 96 \cdot a \cdot l )}{8 \cdot {a}^{4} \cdot l - 12 \cdot {a}^{3} \cdot {l}^{2} + 6 \cdot {a}^{2} \cdot {l}^{3} - a \cdot {l}^{4}} ] \qquad ( 3$$

where E represents the modulus of elasticity of the material of beam 22 and I represents the quadratic moment of the perpendicular section of the beam with respect to the y axis.

This value K_{calculated}(y) must not be confuse with the function K(y) used in equation (2). It is determined by the choice of the [a, g(a)] pair, and is only equal to the function K(y) when x=a.

For a given deviation ymax of the beam 22, the values a and g(a) fix the stiffness of the system. However, there is an infinite number of points [a, g(a)] that can obtain this stiffness for a given stiffness.

During a later step, all the points [ai, g(ai)] that could generate the stiffnesses necessary to obtain the curve V(Δy) initially, are calculated. Consequently, a stiffness K is imposed for a given value of ymax, and the relation (3) is used to determine all points [a, g(a)] that were used to obtain this stiffness.

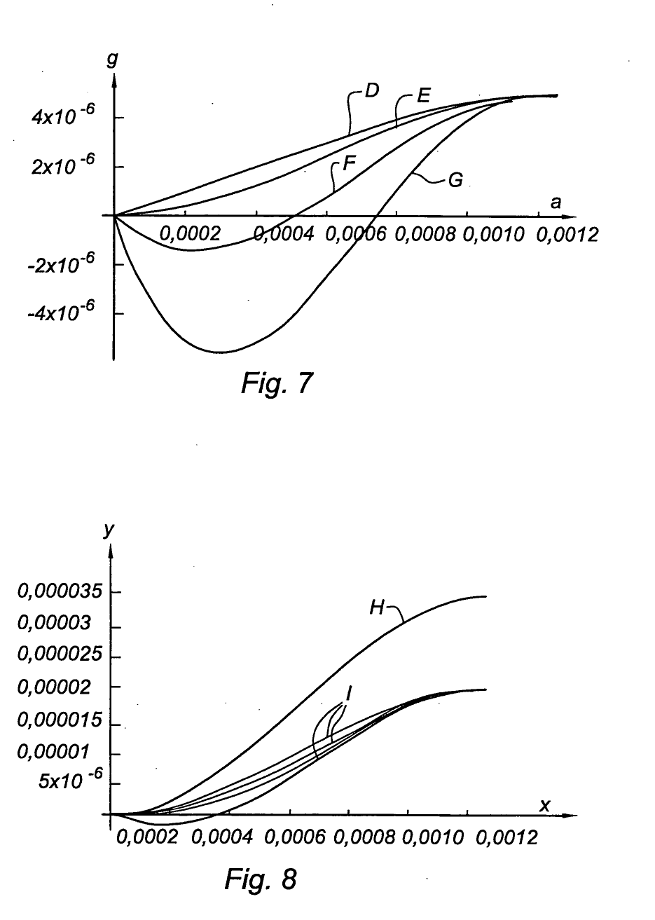

In FIG. 7, each of the curves D, E, F and G represent the set of points [a, g(a)] for stiffness values K equal to 0.1 N/m, 0.57 N/m, 1 N/m and 2 N/m respectively. The curve E obtained for K=0.57 N/m corresponds exactly to the real deformed shape of the beam if there is no support. The curve D that corresponds to a lower stiffness than the initial stiffness of the beam, is not realistic since it would mean that the fixed structure acts on the beam in tension rather than in pressure.

The next step is to identify the set of points [ai, g(ai)]=G(a) that determines the shape of the fixed support, ensuring that these points are compatible with the deformed shape of the structure being deviated. As shown in FIG. 8, a particular deformed shape of the structure corresponds to each pair [ai, g(ai)] for a given stiffness. More precisely, FIG. 8 represents the deformed shape y(x) of the beam in the absence of any support points (curve H) and for values of the [a, g(a)] pair that induce the same stiffness K (curves I).

To identify the set of points [ai, g(ai)]=G(a), the first step is to determine all points [ai, g(ai)] that induce a stiffness k(yi) compatible with each other and with the deformation of the mobile beam. This means that the curve G(a) corresponding to all selected points [ai, g(ai)] must be greater than y(a) for all values of ymax and consequently the derivatives G′(a) at the support points must be greater than y′(a). To achieve this, it is necessary to make sure that the beam actually passes through the point [ai, g(ai)] and only through this point, for each deviation yi.

In practice, the successive points [a, g(a)] of the surface S of the support structure are determined one by one, by scanning the deviation of the beam 22 from the instability point as far as the maximum required deviation. The deviation is broken down into increments for this purpose.

The stiffness K(y) associated with each deviation point y (deflection of the deformed shape), is obtained using relation (2) as described above. FIG. 7 shows the curve of points [ai, g(ai)] that might be generated for this stiffness K. The next step is to determine the point [a, g(a)] corresponding to the deviation considered by comparing the shape of the support with the deformed shape of the structure determined in the previous step, taking account of conditions related to the contact point and the gradient.

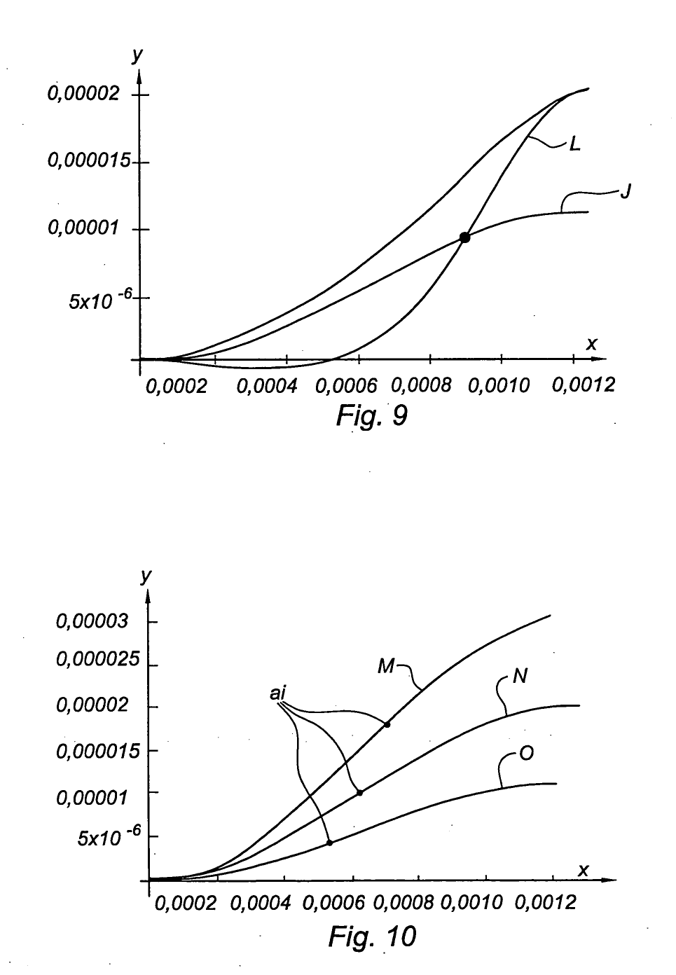

We will now describe how these conditions are taken into account through an example, with reference to FIGS. 9 to 11.

It is assumed that points [ai, g(ai)] were determined as far as deviation y1, which corresponds to a stiffness k1. The corresponding deformed shape is shown on curve J in FIG. 9. The next step is to perform iterations to determine the next point [a2, g(a2)] that corresponds to a deviation y2 greater than y1, this stiffness k2 also needing to be greater than k1.

As described with reference to FIG. 7, the stiffness k2 may also be given by a set of points [ai, g(ai)]. The next step is then to superpose a curve L representing g2(a) for a stiffness k2 on curve J in FIG. 9. All solutions below the intersection point between curves J and L are eliminated, since they are not compatible with the previous deformed shape. This first condition, which is usually written gi(ai)>yj(ai) where j varies from 0 to i-1, is used to determine the possible values of ai.

Moreover, as mentioned above, the choice of a [a, g(a)] pair fixed the value of k, and also the K_{calculated}(ymax). Therefore, it is necessary to make sure that this gradient remains less than the required K(ymax).

Thus, in the second example illustrated in FIG. 10 which shows three possible deformed shapes y(x) at M, N and O, for one value of the [ai, g(ai)] pair inducing the same stiffness K, it can be seen that the points ai corresponding to the curves M and N are too high. Therefore, the first support point of the curve 0 is imposed. Therefore the stiffness of the beam for larger deviations will be imposed by the same point and not by the support points of curves M and N, for which the increase of K(ym) would be too large.

More precisely, the selected point ai (and the associated abscissa g(ai)) is the first point that satisfies the above-mentioned condition.

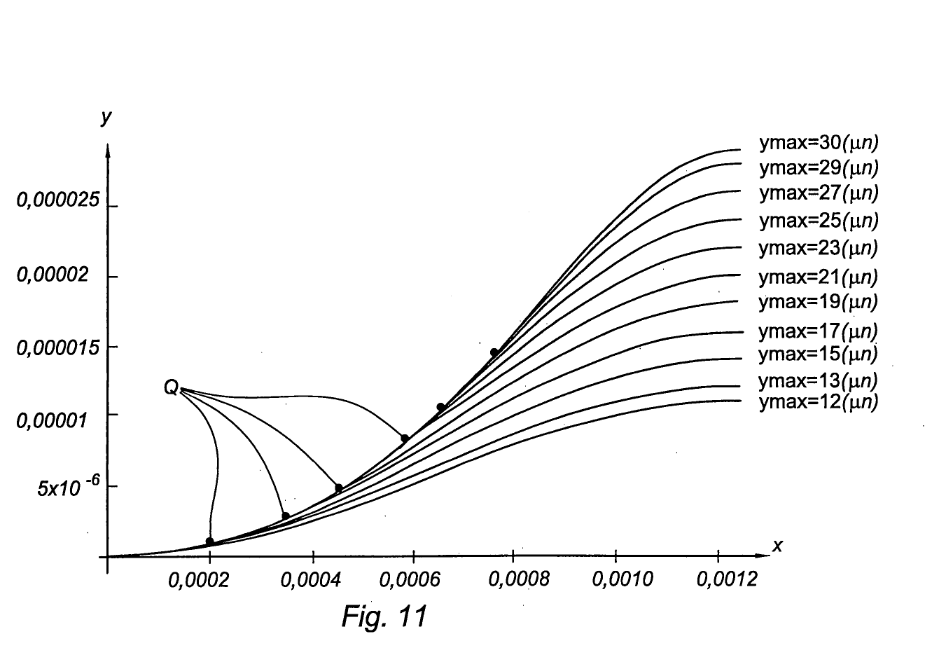

In the numeric example mentioned above, these various constraints have been taken into account to assure that deformation of the beam 22 in FIG. 1 is not incompatible with the topography G(a) of the surface S of the support structure. FIG. 11 shows successive deformations of the beam for a maximum deviation varying from 12 μm to 30 μm in steps of 2 μm. In this figure, the points Q symbolize contact points between the beam and the fixed support for each deviation. Therefore, they represent the shape of the surface S generating the variable stiffness.

The embodiment that has just been described as an example shows that the use of stiffness control means according to the invention is a means of eliminating the instability area, partially linearizing the deformation curve and increasing the amplitude of the deformation for a negligible increase in the control voltage, by assigning a variable stiffness that can be calculated, to the device.

Obviously, the method of calculating the characteristics of the structure generating the variable stiffness is different depending on the nature of the structure. Consequently, the method described above to determine the shape of the surface S in FIG. 1 must not be considered as limiting the scope of the invention. Note also that characteristics used to generate the required variable stiffness can be determine by any appropriate means, particularly including automated calculation means.

The invention can be applicable in many technical domains, and particularly in equipment using electrostatic combs. In particular, the various possible applications include micro deflectors for laser telemetry (detection of automobile obstacles, etc.), reading of barcodes, switching of light beams, reconstitution of scenes, etc., micro switches for spatial switching of light beams, for example in telecommunications for safer switching matrices and reconfiguration of optical fiber networks, optical switches or variable attenuators, etc., membrane structures such as micro-Fabry-Perrot, adaptive optical components, etc.

1. Device comprising a fixed structure (10), a mobile structure (12) connected to the fixed structure by flexible support means (22), and control means (14, 16) capable of displacing the mobile structure, the device having a given global stiffness and being characterized in that the mechanical stiffness control means (22, 17, 26, 26′, 28, 30, 34) are associated with the mobile structure (12) and are capable of modifying the said global stiffness so that it varies with the displacement (F) of the mobile structure (12).

2. Device according to claim 1, in which the stiffness control means (22, 17, 26, 26′, 28, 30, 34) are capable of modifying the global stiffness of the device so that it increases progressively with the displacement (F) of the mobile structure (12).

3. Device according to claim 1 or 2, in which the control means (14, 16) are of the electrostatic type.

4. Device according to any one of claims 1 to 3, in which a beam (22, 17) fixed to the mobile structure (12) bears on at least one point (P) on the fixed structure (10) materializing the stiffness control means, at least one of the elements consisting of the beam (22) and the fixed structure (10) being flexible, and the shape of these elements being such that the location of the said point (P) varies with the deflection of the said flexible element.

5. Device according to claim 4, in which the beam (22) of the stiffness control means is also used in the flexible support means connecting the mobile structure (12) to the fixed structure (10).

6. Device according to claim 4, in which the beam (17) is an element added to the mobile structure (12) and different from the flexible support means (22).

7. Device according to any one of claims 1 to 3, in which the mobile structure (12) bears on an add-on flexible structure (30) materializing the stiffness control means at at least one point (P), the stiffness of the add-on flexible structure (30) varying with the position of the mobile structure (12).

8. Device according to any one of claims 1 to 3, in which the mobile structure (12) is in friction contact with at least one presser device (34) materializing the stiffness control means, the said presser device (34) being applied in contact with the mobile structure (12) with an adjustable pressure.

9. Device according to claim 8, in which the presser device (34) is applied in contact with the mobile structure (12) through a passive means (36).

10. Device according to claim 8, in which the presser device (34) is applied in contact with the mobile structure (12) through an active means (36).
